(19) United States
(12) Patent Application Publication
(10) Pub. No.: US 2008/0305460 A1
(43) Pub. Date: Dec. 11, 2008

(54) TRAINING TECHNIQUE FOR LEARNING AGILE METHODOLOGY

(76) Inventor: Swati Garg, Bangalore (IN)

Correspondence Address: GLOBAL IP SERVICES, PLLC, 10 CRESTWOOD LANE, NASHUA, NH, 03062, US

(21) Appl. No.: 11/747,247

(22) Filed: May 11, 2007

(30) Foreign Application Priority Data
Oct. 12, 2006 (IN) 1894/CHE/2006

(51) Int. Cl. G09B 19/00

(52) U.S. Cl. 434/118

(57) ABSTRACT

A method of training team participants to learn XP practices for generating a required application for a customer includes selectively using a combination of numeric, alphanumeric and pictorial puzzles/brain teasers and a set of role play instructions upon the training team participants learning of theoretical aspects of Agile methodology practices. The method delivers twelve programming practice-requirement-skills of: Onsite Customer, Planning Game, Small Iterations, Simple Design, Metaphor, Re-factoring Metaphor-use, Pair-Programming, Collective ownership, Sustainable Pace, Coding Standards, and Testing and Continuous Integration. The learning kit through timed iterations assists in designing, testing and code-release conforming to coding standards. The learning kit assists in producing the required code for the customer within time constraints of several iteration steps which precede code generation. The participants work and learn in team pairs which can be rotated if necessary.

Benefit is claimed under 35 U.S.C. 119(a) to Indian Provisional Application Ser. No. 1894/CHE/2006 entitled “Practical training on Agile (XP) methodologies through combination of alpha-numeric and pictorial puzzles” by Swati Garg, filed on Oct. 12, 2006.

### FIELD OF THE INVENTION

The present invention generally relates to a training method and a learning kit for use by participants to quickly and effectively understand and implement Agile methodology. More particularly, the invention relates to a learning kit for explaining Extreme Programming (XP).

### BACKGROUND OF THE INVENTION

The concept of using learning kits to group-train software practitioners to learn generic software development techniques is used with several advantages. The group-training assists in reinforcing the concepts for suitable development approach using existing established methodologies. One such established software-development methodologies is Agile. Agile is a customer focused development methodology in which customer's changing requirements are considered and implemented through small iterations of project execution. Agile methodologies are driven by a set of values and principles defined and agreed through www.agilemanifesto.org. Also, Agile is a practical and proven methodology for software project developments because of the very fact that it is instituted by software practitioners. Agile is known to be in formal existence since 2001, and many companies across the glove have derived productivity and quality benefits through the application of Agile methodologies.

One of the most popular Agile methodologies for software development is known as XP. Typically, XP involves developing software through several small iterations of incremental delivery. The entire project team works in close collaboration with the customer. Generally, XP is performed using the 12 core XP practices named as Metaphor, Onsite customer, Planning Game (which can include activities, such as Release Plan, Iteration Plan, Visual control, and Daily standup meeting), Small Release, Sustainable Pace, Simple Design, Re-factoring, Test First Development, Pair-Programming, Coding Standards, Continuous Integration, and Collective ownership. The XP Team includes key roles, such as Customer, XP Coach, XP Programmers and Testers. The XP Team also includes some more roles, such as Project Manager, Tracker, and Consultant.

The customer's requirements in the XP projects are expressed as “Story Cards”, i.e., the story cards represent a fully implementable feature/functionality defined in the user terms. The story cards are basic building blocks for software development through XP. Relationship among story cards is defined by the business rules of the customer's business domain. Several story cards that relates to each other can form different sub systems that can influence the final system ultimately. The story cards are primarily written by customer and well understood by the project team before implementation. The customer may give several story cards to start the project; however, the team can limit the number of story cards to a smaller number for implantation in any given iteration by selecting high priority story cards. The customer can also change or add story cards at the end of any iteration.

Available learning approaches for coaching teams in learning software development practices, such as XP methodology through a learning kit addresses the XP practices with varying degrees of success and efficacy. The current learning approaches do not cover all 12 core XP practices, which explain XP in a seamless manner. Further the current techniques do not encompass XP practices such as Metaphor, Test First Development, Simple Design, Re-factoring, Coding Standards and Continuous Integration. Furthermore, the current learning techniques are technology dependent and require considerable computing power to execute them.

### SUMMARY OF THE INVENTION

The present approach provides a learning kit for teaching and understanding the Agile methodologies, such as XP, wherein 12 different XP practices are covered by selectively using the iterations, numeric, alphanumeric and pictorial puzzles/brain teasers that are being driven in a guided manner. In the form of a learning kit, the present approach enables a software project team to stay focused towards delivery of high quality software to a customer while accommodating changing needs of the customer and reducing the time taken to mark the final deliverables.

This subject matter (Extra Power Game-Learning Kit) explains the XP in an experiential, retrospective and fun driven manner. This Learning Kit is very unique for the following key reasons:
It covers at least 12 XP practices in a seamless manner.
There is no existing learning kit that encompasses following XP practices:
   1 Metaphor
   2. Test First Development
   3. Simple Design
   4. Re-factoring
   5. Coding Standards
   6. Continuous Integration
This learning kit does not depend on any specific technological background.
There is no computer aid needed while executing it (though computer simulation is possible) and
It involves very little cost in terms of inventory for the learning kit creation and repeated execution.

### BRIEF DESCRIPTION OF THE DRAWING

A more detailed understanding of the invention may be had from the following description of exemplary embodiments to be understood in conjunction with the accompanying drawing where:

FIG. 1 an example flow chart that illustrates a method of training team participants in learning Agile methodology for generating a required application.

FIGS. 2-4 illustrate story cards created for learning according to the teachings of the present subject matter.

FIG. 5 is an example true live picture that illustrates a final solution obtained by one of the subgroups that participated in the learning kit execution.

### DETAILED DESCRIPTION

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

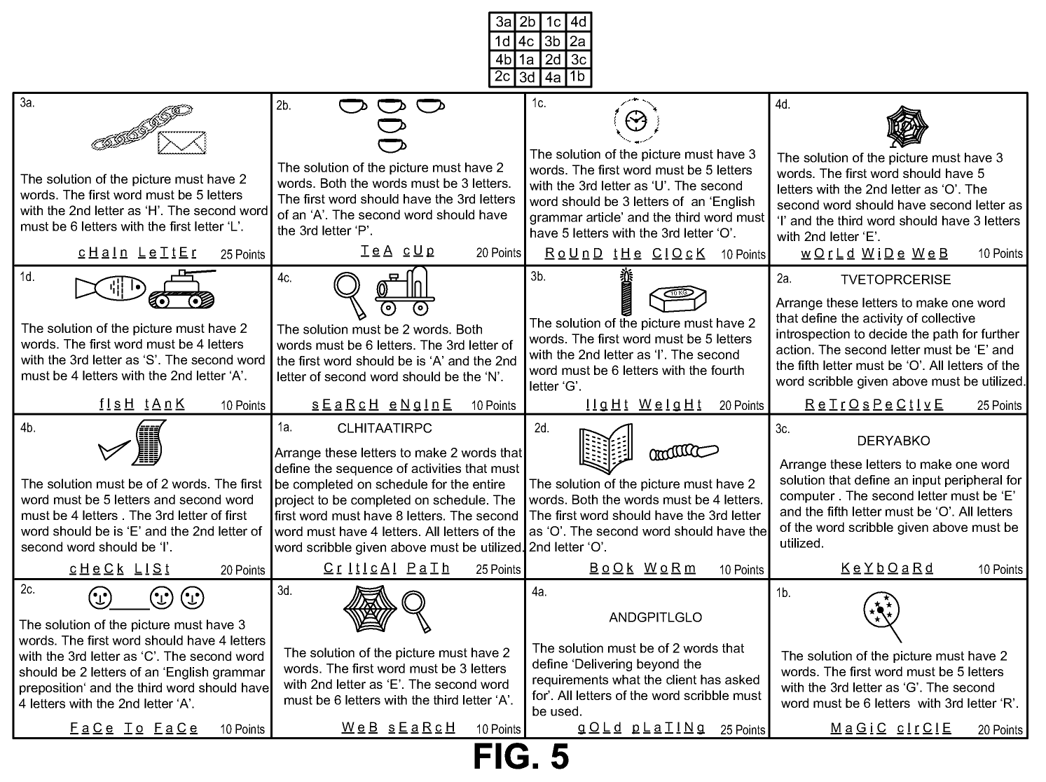

The terms “training technique”, “learning kit”, and “XP game” is used interchangeably throughout the document. The term “application” refers to a desired outcome of the present technique. For example, the desired outcome of the present technique is as shown in FIG. 5. Furthermore, the terms “game,”, “Extra Power Game-Learning Kit” and “XP Game-Learning Kit” are used interchangeably throughout the document.

In the following example Extra Power Game-Learning Kit is conducted substantially after completing the theoretical session on XP practices. However, this learning kit can also be performed independently or differently, for those who already have good understanding of the theoretical aspects of XP, in a separate session or by an individual study using available reading material on XP. Detailed structure of the present subject matter (Extra Power Game-Learning Kit) is covered in the following paragraphs.

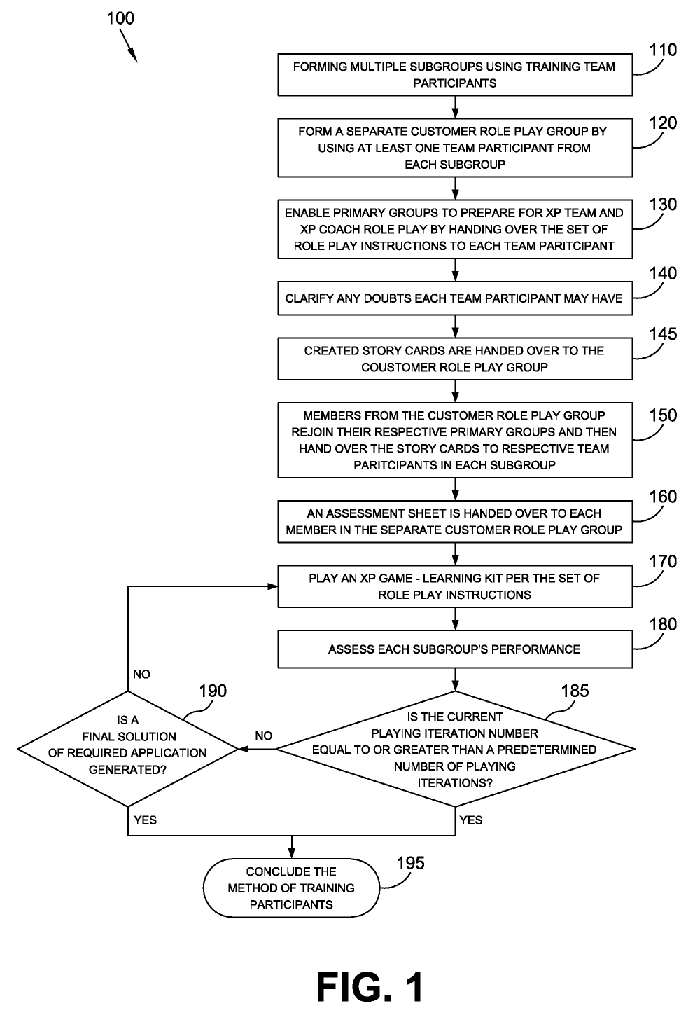

With specific reference to the exemplary process 100 illustrated in FIG. 1, the flowchart process and decision elements are associated with a corresponding reference number. For details on the decision elements, the following explanation is provided:

The process 100 begins with forming multiple subgroups using training team participants. In these embodiments, each subgroup plays a predetermined number of roles to be performed by the training team participants. In these embodiments, the predetermined number of roles is substantially less than the number of training team participants. The predetermined number of roles can include roles, such as customer, Agile coach, faculty/instructor, consultant, Agile team and so on. Also in these embodiments, all the training team participants (the number of participants in one session may vary) in the training workshop are divided into smaller primary groups of equal size (for example, 6 to 8 members per group) to initiate the Extra Power Game-Learning Kit. Each subgroup may have 3 role plays to be preformed by the training team participants. Exemplary role play can be namely a customer (played by one member of the group), an XP coach (played by different members of the subgroup for different iteration. Each member within the subgroup may be given a chance to act as the XP coach in at least 1 iteration) and the XP team (played by all members of the subgroup—other than the member playing as the customer). In some embodiments, the role of the XP Manager and Tracker is assumed with the member who plays as the XP coach. The faculty/instructor (can be one or more individuals) of training workshop session plays the role of a consultant.

At step 120, a separate role play group is formed using at least one team participant from each subgroup to prepare differently from each of the remaining subgroup participants. In some embodiments, after the primary groups are formed to run Extra Power Game-Learning Kit, the respective group's members who are assuming to play role of customer are requested to come out of their group. The representative from each primary group from a secondary group so that they can be prepares differently than the rest of the members of their primary group.

At step 130, the st of role play instructions is handed over to each team participant by an associated faculty/instructor. In these embodiments, the faculty/instructor of the training workshop enables the customer role-play preparation by handing over following artifacts to respective members within the secondary group. In some embodiments, direct solution is not included in these instructions. If the members playing as customer are curious to know the actual solutions for the sake of understanding then the training session instructor can show them some examples of the solution keys described in later sections.
Following illustrate an exemplary written set of role play instructions that may be handed over by the associated faculty/instructor to each member of the customer role play group:
   a. Go back to join in the group that represents your XP team,
   b. Show 10 story cards to the team,
   c. Start with the prime requirements by expressing that these stories that need to be implemented based on certain business reasons (rules) that connects these stories.
   d. Use metaphor: Say it's like solving ‘Sudoku’.
   e. Tell the business rules are:
      i. Rule 1: Arrange 4 numbers (1, 2, 3, and 4) in the fields of an array of 4×4 fields so that no number repeats in a row, column or block of 4 fields in each quadrant.
      ii. Rule 2: Starting from lower right corner of the grid, all the numbers must fall in corners in clockwise manner.
      iii. Rule 3: For the central square of fields. All numbers must follow anticlockwise pattern and no number must repeat on any diagonal.
      iv. A copy of the picture below can be given to team to explain the above said business rules and to facilitate the architecture that follows ‘Sudoku’ as metaphor.

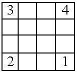

v. Rule 4: Add letters (a, b, c, d) to each number placed within the array in such a way that each number gets association with each letter only once (For example 1a, 1b, 1c, 1d) and no letter repeats in a row, column or block of 4 fields in each quadrant.
f. Tell the team that I want to achieve the ‘Extra Power’. The numbers arranged on one of the diagonal must fetch the highest number when arranged in exponential order starting from top corner [For example: (((2)³)⁴)¹]. At the end of architecture the team should be able to inform which one is the ‘Extra Power’ diagonal.
g. Do not share following details unless the team asks you relevant questions to get this information out.
h. If they ask then tell about your priority. Tell them that each story card has a unique identifier ((1a, 1b, . . . 4c, 4d—the letters in each story represents the priority of story, ‘a’ for priority 1 stories, ‘b’ for priority 2 stores, ‘c’ and ‘d’ for lower priority).
i. If the team asks the basis for priority then tell that it is based on business value that is defined by the end customer.
j. If they ask that who is the end customer then reply that end customer is an educational institute that wants to use the outcome for teaching purpose.
k. If team then tell them about coding standards:
   Follow the alternate case letters (For Example: AlTeRnAtE).
   The story card located at top left corner must start with small case letter.
   Continue to follow the alternate case letter across the row. (For Example: SoLuTiOnOnE, sOlUtIoNtWo)
   Based on the last letter of the right hand side solution of the row above, the left hand side solution of the subsequent row must follow the alternate case letter, (For Example: if the right hand side solution of the row above is SoLuTiOnFoUr then the next row's left hand side solution must be written as ‘SoLuTiOnFiVe)
l. If team asks then tell them about writing the test cases. Tell them that all ‘Should be’ and ‘Must be’ condition have to be tested. Give example that if the story card is as below:
   ‘Picture’: the solution must be 2 words. The first word must be 5 letters and second word must be 4 letters. The 3rd letter of first word should be is ‘E’ and the 2nd letter of second word should be ‘I’.
   The test case for this story is ‘_{— —}E_{— —}’ ‘_I_{— —}’.
m. If the team ask for the consultant: You can agree to provide the consultant help free of cost for 75% of planned work is done during the iteration, otherwise consultant involvement will incur a 50% loss of points against that activity. Except architecture phase do not agree for consultant, rather tell the team to de-scope. Provide consultant only if they have failed to achieve the solution in 2 iteration.
n. Do not accept the story that is not integrated in the business rules alphanumeric grid.
o. Continue to observe the teams' activities: Especially coach's activities and assign the points in the assessment sheets based on the performance.

At step 140, any doubt each team participant may have is clarified by the associated faculty/instructor. In some embodiments, participants of the ‘customer role play’ secondary group can ask clarifications to the faculty of the training workshop. In these embodiments, the faculty prepares themselves using all the answer keys to role play as consultant provided to them to answer any questions asked by the training team participants. On completion of the ‘customer role play’ preparation, this secondary group is dissolved and all the members of this group have to resume back in their primary group as the customer of the respective primary groups.

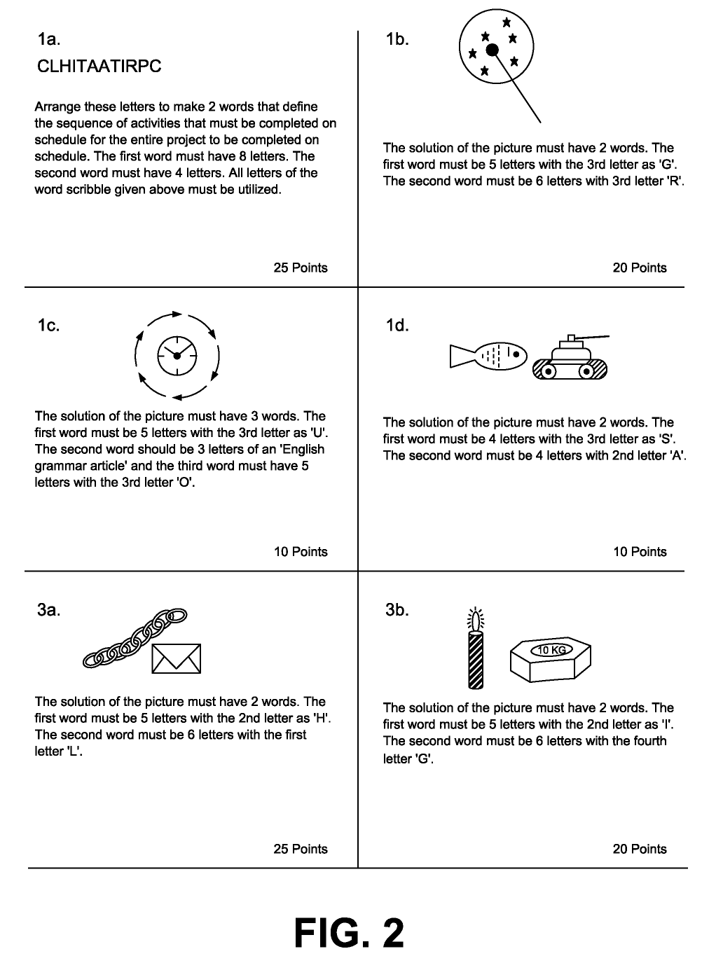

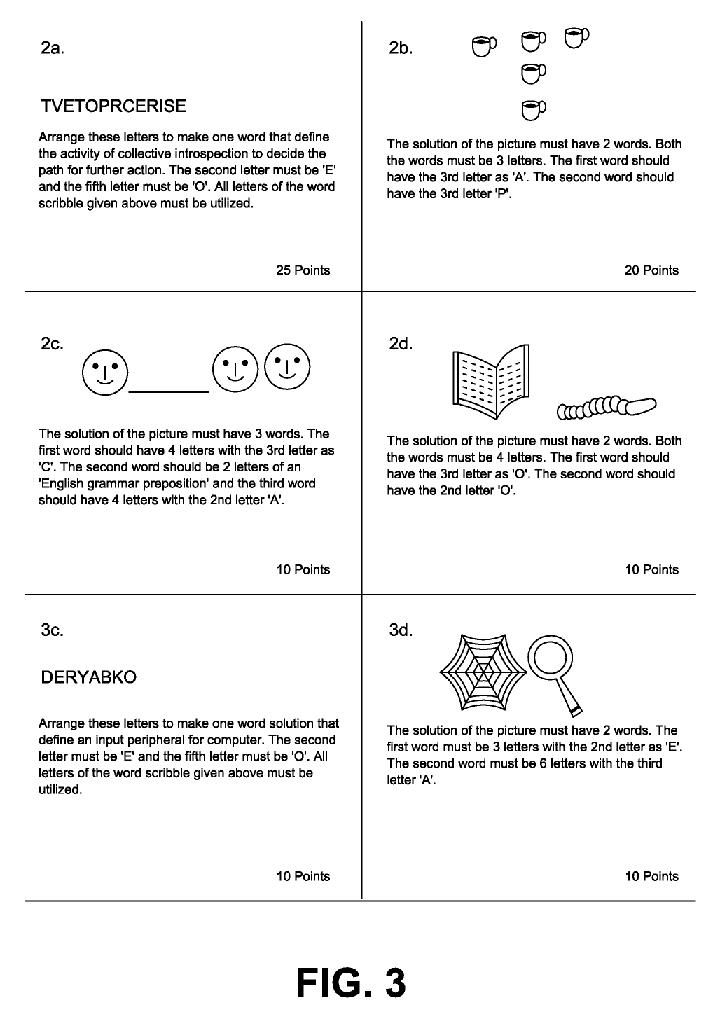

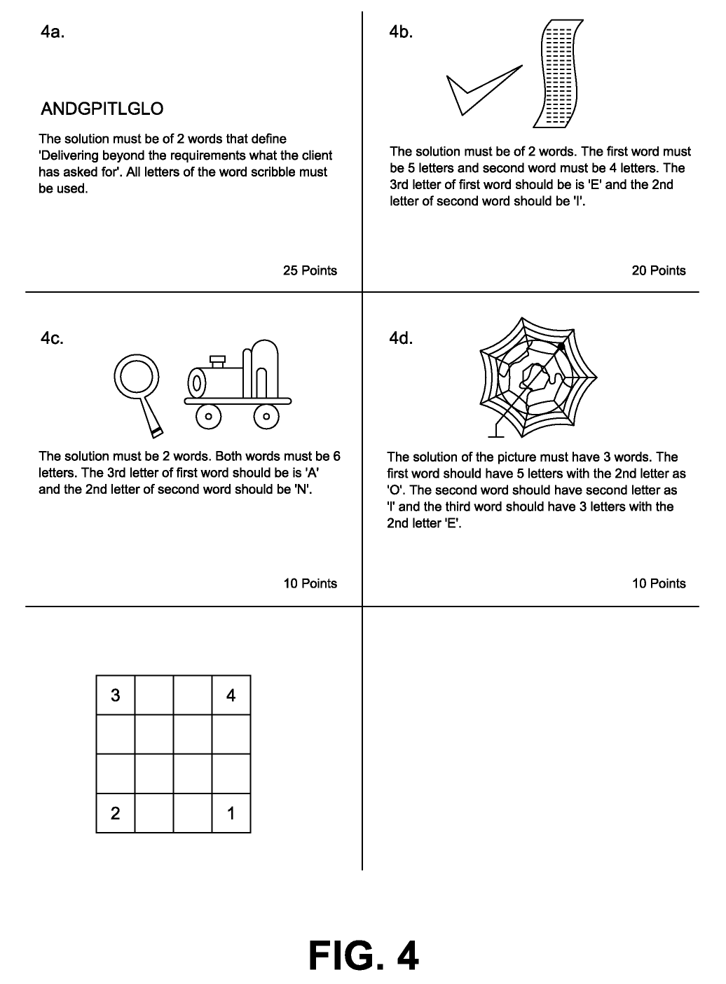

At step 145, created story cards are handed over to the customer role play group. At step 150, members from the customer role play group rejoin their respective primary groups and then hands over the story cards to respective team participants in each subgroup. In some embodiments, the story cards are predefined story cards as shown in FIGS. 2-4. As shown in FIGS. 2-4, the story cards are presented in a hand written form including puzzles. Some intentional mistakes are introduced in these story cards to trigger the dialogues between team and customer. The priority of each story card may be defined with the help of labels ‘a’, ‘b’, ‘c’ and d’. Wherein the label ‘a’ can represent the highest priority.

At step 160, an assessment sheet is handed over to each member in the separate customer role play group so that each team participant playing the customer role can assess their associated subgroup's performance.

Following are some example assessment sheets for respective groups:

Score card for coach's performance during the Planning phase/Architecture iteration:

| | | Score (10 or |
|---|---|---|
| | Criteria to score - 10 point if the criterion is | Zero for each |
| S. No. | met, ‘zero’ if the criterion is not met | criterion) |
| 1 | He/she is ensuring that team communicates | |
| | with customer to understand the look and feel | |
| | of story card. | |
| 2 | He/she is ensuring that the team clarifies | |
| | doubts of business rules. | |
| 3 | He/she is guiding the team to make the high | |
| | level plan and estimate for implementation in | |
| | iterative approach. | |
| 4 | He/she is guiding team to utilize the remaining | |
| | time for creating the architecture. | |
| 5 | He/she is guiding the team for using simple | |
| | design approach. | |

Score card for Team's performance during the Planning phase/Architecture iteration:

| | | Score |
|---|---|---|
| S. No. | Criteria to score | (Tick as applicable) |
| 1 | Architecture achieved | Give 100 points |
| 2 | Consultant's help after 75% of work done | Just tick |
| 3 | Consultant's help before 75% of work | Reduce half points |
| | done | |
| 4 | Coach's score | |

Score card for coach's performance during the Stories implementation iterations:

| | | Score (10 or |
|---|---|---|
| | Criteria to score - 10 point if the criterion is | Zero for each |
| S. No. | met, ‘zero’ if the criterion is not met | criterion) |
| 1 | He/she is ensuring that team focus on iteration | |
| | planning. | |
| 2 | He/she is ensuring that the team follows visual | |
| | tracking. | |
| 3 | He/She is guiding the team to follow daily | |
| | stand up meeting. | |
| 4 | He/she is guiding team towards pair | |
| | programming. | |
| 5 | He/she is guiding the team for promoting | |
| | coding standards. | |
| 6 | He/she is facilitating re-factoring | |
| 7 | He/she is promoting collective ownership | |
| 8 | He/she is promoting test first development | |
| 9 | He/she is using metaphor. | |
| 10 | He/She is promoting continuous integration | |

Scoring mode for Team's performance during the Story Cards Implementation iterations:

| S. No. | Description | Score |
|---|---|---|
| 1 | Solving priority 1 stories | 25 |
| 2 | Solving priority 2 stories | 20 |
| 3 | Solving stories below priority 2 | 10 |
| 4 | Meeting iteration's story selection logic | 25 |

Score card for Team's performance during the Story Cards Implementation iterations:

| | | Score |
|---|---|---|
| | | (Tick as |
| S. No. | Criteria to score | applicable) |
| 1 | Number of priority 1 stories completed | |
| 2 | Number of priority 2 stories completed | |
| 3 | Number of stories below priority 2 | |
| | completed | |
| 4 | Consultant's help after 75% of work done | Just tick |
| 5 | Consultant's help before 75% of work done | Give half points |
| 6 | Coach's score | Sum |
| 7 | Iteration's story selection logic met | |

At step 170, the game is played per the set of role play instructions and the created story cards iteratively by the team participants until the required application is achieved by any one of the subgroups. In some embodiments, rest of the primary groups members are handed over the following instructions to prepare as ‘XP teams’ and ‘XP coaches’:
a. Each team will have 1 member playing the role of customer, who will also maintain score of team.
b. Time boxing of 10 minutes will be followed for all activities during the game. First 10 minutes will be the planning phase; next 10 minutes will be the architecture iteration after which the story cards implementation iteration will start. Each iteration starts with estimation (Approximately 2 minutes) and ends with acceptance by customer (Approximately 1 minute).
c. Between each time box we will have 5 minutes change over. Change over minutes will be used for explanation and understanding of activities with respect to the real life project execution scenarios. Change over minutes will be used for selection of next coach, ‘stop iteration’ message and confirmation of stories completed.
d. Team must ask questions to customer if they need clarity on story cards or test cases or coding standards. Team will be writing test case for respective story cards.
e. If team is not able to achieve the architecture or solve a story then they can ask for external consultant's help (Customer will wear the hat of consultant—team may incur some cost for external help. They must settle the cost with customer during the release planning.)
f. Team must participate in daily standup meeting. Stand-up meeting will be called every three minutes. (Participants: 1 person from each pair and Agile coach). The team members reply 3 questions: What has s/he done so far? (Answer: Story card number: Started, in progress) What does s/he plans to do? (Answer: Story card number: In progress, finish). What is stopping/road block (Answer: None, need help from consultant)
g. As you become coach you need to ensure that visual tracking mechanism is followed. Use the story board/visual tracking chart to show the movement of story cards. (In the starting all story cards will be in the Backlog queue. As soon as the story card is picked for solution then it is considered to be in ‘In Progress Queue’ unless the testing and integration is completed. The story card is moved in to the ‘Release’ queue for customer acceptance at the end of iteration).
h. Team must keep the customer informed about all decisions that they make.
i. Following is an example scoring model that can be used to score during the game:

| S. No. | Description | Score |
|---|---|---|
| 1 | Achieving the architecture | 100 |
| 2 | Solving priority 1 stories | 25 |
| 3 | Solving priority 2 stories | 20 |
| 4 | Solving stories below priority 2 | 10 |
| 5 | Meeting iteration's story selection logic | 25 |
| 6 | Coach - iteration criteria implemented (per line item) | 10 |

Following are some specific example instructions that can be followed during the game:

Example Instruction for Coach: Specific to Planning Phase and Architecture Iteration
a. Ensure that team communicates with customer to understand the look and feel of story card.
   Tell the team to listen to customer.
   As soon the customers explanation is over then tell the team to ask how priority1, priority2 and lower priority is depicted by customer.
   Tell the team to ask on what basis customer has decided the priority.
   Tell the team to ask about the coding standards to solve these stories.
   Tell the team to ask the customer how to test these stories.
   Tell the team to not to jump on solution at this point in time.
b. Ensure that the team clarifies doubts of business rules.
   Ask the customer about metaphor. The metaphor is ‘Sudoku’ because the customer will use this as guiding principle for implementation of business rules.
   Ask the team to check with customer that what will take if they are not able to achieve the architecture within the time box. Suggest team to negotiate for consultants help.
c. Guide the team to make the high level plan and estimate for implementation in iterative approach.
   Ask them to plan that first they must device the number grid (1, 2, 3, 4 number Sudoku) and then they must go about filling in the letters in Sudoku manner (a, b, c, d).
   Keep them away from planning too much in advance. Tell that we should be able to handle combination of 4+/− story per iteration.
d. Guide the team to utilize the remaining time of planning phase for creating the architecture.
e. Guide the team for using simple design approach during architecture activities.
   Ask the team to first create the number grid
   Then suggest them to start filling the letters using the simple order of a, b, c, d in the first row.
   Later the complexity will evolve by itself due to game rule of Sudoku.
   Ask the team to find out which of the diagonal is ‘Extra power’. The ‘Extra power is achieved when the numbers arranged on one of the diagonal fetch the highest number when arranged in exponential order starting from any corner [For example: (((2)³)⁴)¹].

Example Instructions for Coach: Specific to Story Cards Implementation Iterations:
a. Guide team to stay focused on iteration planning. Suggest them to pick story cards based on customer priority and technical relationship. Suggest them to include estimation for story card analysis, writing test case, writing answers by following coding standards, continuous integration and re-factoring.
   Ask the team to use the technical relationship of stories within a row, so that each row will show up as a subsystem ready.
   Ask the team to inform customer that due to technical dependencies team has chosen a different set of stories than all high business value ones.
b. Follow visual tracking: use the team chart to show the movement of story cards. As you become Agile coach you need to ensure that visual tracking mechanism is followed. Use the story board/visual tracking chart to show the movement of story cards. (In the starting all story cards will be in the Backlog queue. As soon as the story card is picked for solution then it is considered to be in ‘In Progress Queue’ unless the testing and integration is completed. The story card is moved in to the ‘Release’ queue for customer acceptance at the end of iteration/time box.)
   Suggest the team to de-scope if they have chosen too much to do in the current time-box.
c. Follow daily stand up meeting: Stand-up meeting is called every three minutes. Since first 2 minutes of iteration has gone in estimation, your first call of stand up meeting will be at 5^{th} minute. Similarly the next stand up meeting will occur at 8^{th} minute. Effectively you will conduct 2 daily stand-up meetings in each of the implementation iteration. (Participants: 1 person from each pair and Agile coach). The team members reply 3 questions: what has he/she done so far? (Answer: Story card number; Started, in progress) What does he/she plans to do? ((Answer: Story card number; In progress, finish). What is stopping/road block (Answer: Need help from Consultant)
d. Use metaphor to guide the team. The metaphor is Sudoku.
e. Promote pair programming. Ask two people to work together to have online review of coding standards (The coding standard: All solutions must be written in alternate case letter across the row. (For Example: SoLuTiOnOnE, sOlUtIoNtWo))
f. Promote test first development: Suggest the team to write the test case before they write the solution for story card.
g. Promote adherence to coding standards.
h. Facilitate re-factoring; Mostly there will be instances of deviation from coding standards. Suggest the team to re-factor at regular intervals to maintain the good quality of solutions (code).
i. Promote collective ownership by suggesting everybody to participate in re-factoring.
j. Promote continuous integration. As soon as a story card solution is ready, ensure that it is joined to other available story cards using the adhesive tape.

In some embodiments, the faculty/instructor (can be one or more individuals) of training workshop session plays the role of Consultant. He/She can provide help to all the primary groups on need basis (The need has to be agreed by the member who is playing the role of customer for that primary group). The consultant will have all the solutions for combination of numeric, alphanumeric and pictorial puzzles/brain teasers that are used in the Learning kit. Solutions, for given example, of the invention (Extra Power Game-Learning Kit) are listed as below:

Following can be the solution key for possible numeric grid that can be created by the team based on the business rules shared by the customer. For details on customer's business rules refer to the above described instructions.

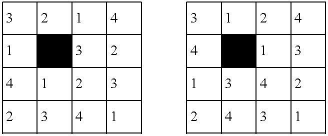

It can be seen that the Extra Power diagonal is starting from the left hand side top corner by fetching the exponential value of (((3)⁴)²)¹ or (((3)²)⁴)¹=6561.

The other diagonal values are as below:
The diagonal starting from upper right corner brings values of (((4)³)¹)² or (((4)¹)²)²=4096
The diagonal starting from lower left corner brings values of (((2)¹)³)⁴ or (((2)³)¹)⁴=4096
The diagonal starting from lower right corner brings values of (((1)²)⁴)³ or (((1)⁴)²)³ =1

It can be seen that there is a prominent difference in the number in the ‘grey’ cells. If the team fails to devise alphanumeric solution based on the business rule explained by the customer then they can ask for the help from the training faculty/instructor who is playing the role of consultant. The faculty can offer the one of the solution listed based on the ‘digit’ corresponding to the ‘grey’ cell in team's numerical solution.

Below are the example keys of most preferred solutions for devising the alphanumeric grid that would work as the architecture for the overall solution of the Extra Power-Learning Kit.

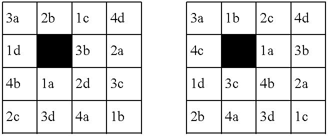

However, it is possible to create several other combinations of alphabetical characters within purview of the business rules shared by the customer to the team; two such example solutions are listed below:

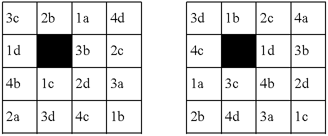

In some embodiments, if the team succeed in designing an alphanumeric grid that is valid according to the business rules defined by the customer where in the solution is not same as the any one of the preferred solutions as listed above then the Team and the coach losses the points that are awarded against the simple design practice.

At step 170, Following are some example solutions keys for story cards shown in FIGS. 2-4:
1a. Critical path
1b. Magic circle
1c. Round the clock
1d. Fish tank
2a. Retrospective
2b. Tea cup
2c. Face to face
2d. Book worm
3a. Chain letter
3b. Light weight
3c. Keyboard
3d. Web search
4a. Gold plating
4b. Check list
4c. Search engine
4d. World wide web

At step 180, each subgroups's performance is assessed by an associated team participant playing the customer role. In some embodiments, the faculty/instructor can show some of the solutions to members who are doing customer role play to build understanding of desired outcome of the execution of the Extra Power Game-Learning Kit.

At step 185, the method 100 determines whether the current playing iteration number is equal to or greater than a predetermined number of playing iterations. In some embodiments, the faculty/instructor (can be one or more individuals) of the training workshop ensures that the time boxed iterations (10 minutes per iteration in the given example of this invention) are followed by all participants. The faculty observes the activities performed by the each group and at the end of each iteration explains the learning achieved by each group. The member playing as customer for respective group performs assessment at the end of every iteration.

Based on the determination at step 185, the method 100 goes to step 195 and concludes the method of training the team participants if current playing iteration number is equal to or greater than the predetermined number of playing iterations. The method 100 goes to step 190 if the current playing iteration number is not equal to the predetermined number of playing iterations. At step 190, the method 100 determines whether a final solution of the required application is generated. Based on the determination at step 190, the method goes to step 195 and concludes the training of the team participants if the final solution to the required application is generated. Based on the determination at step 190, the method goes back to step 170 and repeats steps 170-195 if the final solution to the required application is not generated. In some embodiments, the team participants of the training workshop continue to play the game (i.e., the Extra Power Game-Learning Kit) until one of the primary groups achieve the end solution of the learning kit. FIG. 5 shows sample end solution that can be achieved at the end of playing the above-described game. In some embodiments, the faculty may stop further execution if no team is able to achieve the end solution however all the learning are well conveyed to participants through a few run of iterations in the given/available time to run the Learning Kit. Upon concluding the game based on the above-described process the training team participants would have understood almost all the 12 XP practices.

Following tables outline the example learning achieved by the training team participants upon playing the above-described game (Extra Power Game-Learning Kit).

TABLE I
Lists learning offered based on listed XP practices (using the given example of
this invention) while playing the first iteration (planning phase) and the second iteration
(architecture iteration) activities of Extra Power Game - Learning Kit. The listed activities
of Extra Power Game - Learning Kit in the following table-1 offer a better understanding
of corresponding XP Practices:

| S. No. | XP Practice | Learning Kit Activity |
|---|---|---|
| 1 | Onsite Customer | One dedicated participant plays role of ‘Onsite Customer’. He/She is |
| | | made available with the group (team) on full time basis to provide |
| | | required inputs, answer the questions, change/add story cards and |
| | | negotiate for consultants' availability. |
| 2 | Planning Game | Team at high level understands the details (business rules and the |
| | (Release Plan) | story cards) shared by customer and decides road map to go forward. |
| 3 | Small Release | The fixed time boxed iterations of 10 minutes duration are defined to |
| | | take the Extra Power Game - Learning Kit to its completion. |
| 4 | Metaphor | In this example of Extra Power Game - Learning Kit the team uses |
| | | ‘Sudoku’ as metaphor. This metaphor helps the team to devise the |
| | | high level architecture. Then team picks the story cards for the |
| | | iterations in a manner that relates to ‘Sudoku’ rules as defined by the |
| | | customer. The team continues to follow the ‘Sudoku’ as guiding |
| | | principle while working towards completion of ‘Extra Power - Learning |
| | | Kit’. |
| 5 | Simple Design | The simplest approach is followed to create the architecture based on |
| | | the business rules defined by customer. |
| 6 | Collective ownership | Everybody in the team participates to create the architecture based |
| | | on the business rules defined by customer. |
| 7 | Sustainable Pace | The team participates in estimation and decides number of required. |
| | | The team tries to achieve the plan in iteration time. Overwork and |
| | | under utilization is avoided. |

TABLE 2
Learning is offered towards listed XP practices (using the given example of this
invention) while playing the story cards implementation iterations' activities of Extra
Power Game - Learning Kit. In other words, the listed activities of Extra Power Game -
Learning Kit offer understanding of corresponding XP Practices in the table below.

| S. No. | XP Practice | Learning Kit activity |
|---|---|---|
| 1 | Onsite | One dedicated participant plays role of ‘Onsite Customer’. He/She is made |
| | Customer | available with the group (team) on full time basis to provide required |
| | | inputs, answer the questions, change/add story cards and negotiate for |
| | | consultants' availability. |
| 2 | Planning | The team makes a high level execution plan (Release Plan) in customers |
| | Game | presence based on the inputs provided during the first iteration (Planning |
| | (Release | phase). |
| | Plan, | Team members pick story cards to implement in the iteration. They |
| | Iteration | estimate the time/effort required for implementation of selected story |
| | Plan, Visual | cards. |
| | control, | Visual control: the coach uses the story board to show the movement of |
| | Standup | story cards (In the starting all story cards will be in the Backlog queue. As |
| | Meeting) | soon as the story card is picked for solution then it is considered to be in |
| | | ‘In Progress Queue’ unless the testing and integration is completed. The |
| | | story card is moved in to the ‘Release’ queue for customer acceptance at |
| | | the end of iteration). |
| | | Stand-up meeting is called every three minutes. (Participants: 1 person |
| | | from each pair and Agile coach). The team members reply 3 questions: |
| | | What has he/she done so far? (Answer: Story card number: Started, in |
| | | progress) What does he/she plans to do? ((Answer: Story card number: In |
| | | progress, finish). What is stopping/road block (Answer: Need help from |
| | | Consultant). |
| 3 | Small | The fixed time boxed iterations of 10 minutes duration are defined to take |
| | Release | the Extra Power Game - Learning Kit to its completion. |
| 4 | Simple | The simplest approach is followed to create the architecture based on the |
| | Design | business rules defined by customer. |
| 5 | Refactoring | It is triggered due to the coding standards that call for inputs from evolving |
| | | solution of neighboring stories. |
| 6 | Metaphor | In this example of Extra Power Game - Learning Kit the team uses |
| | | ‘Sudoku’ as metaphor. This metaphor helps the team to devise the high |
| | | level architecture. Then team picks the story cards for the iterations in a |
| | | manner that relates to ‘Sudoku’ rules as defined by the customer. The |
| | | team continues to follow the ‘Sudoku’ as guiding principle white working |
| | | towards completion of ‘Extra Power - Learning Kit’. |
| 7 | Pair | The team works on each story card by pairing up. Pairs rotate from |
| | Programming | iteration to iteration as one of them has to move out to take up the Agile |
| | | coach role. One pair finishes 1 story card before working on next story |
| | | card. If a pair can not resolve a card then they ask other team members |
| | | and finally they decide to take help from consultant. |
| 8 | Collective | Everybody in the team participates to re-factor the story cards within the |
| | ownership | architecture and ensures that they do not break anything else. |
| 9 | Sustainable | The team participates in estimation and decides number of required. The |
| | Pace | team tries to achieve the plan in iteration time. Overwork and under |
| | | utilization is avoided. |
| 10 | Coding | All solutions (code) for implementing respective story cards must be |
| | Standards | devised through proper coding standards. Customer defines the coding |
| | | standards to the team. Alternate case letters are used as the Coding |
| | | Standards. |
| 11 | Testing | All ‘must be’ and ‘Should be’ conditions within story cards are utilized for |
| | | writing the test case. The test case are devised based on thorough |
| | | understanding of story cards and solution (Code) is devised against the |
| | | test case. |
| 12 | Continuous | The story card in iteration is considered for scoring only if the story card for |
| | Integration | which the solution is devised, is integrated (placed at the appropriate |
| | | position in the business rule's alphanumeric grid (with the help of adhesive |
| | | tape) on immediate and continuous basis. |

Following is an exemplary list of inventory that can be used by each participating group for playing the above example game (Extra Power Game-Learning Kit):
a. 2-3 plain paper sheets to devise the architecture and final copy of architecture to be referred
b. 3-4 plain papers for story cards
c. 1 Adhesive tape to integrate the story cards
d. 1 scissor for cutting the tape
e. 3-4 pencils and erasers
f. 1 A-2 card sheet for visual tracking chart
g. 1 pack of small post-it to show the movement of story cards
h. 1 Instruction sheet per participant to set the ground for game

Overview of an embodiment of the Learning Kit: Extra Power as aforesaid is a learning kit that is used to coach the software practitioners and leaders by selectively using combination of numeric, alphanumeric/pictorial puzzles and brain teasers for adopting the XP methodology. This is a fun driven, inspirational, experiential and retrospective learning approach which helps participants to identify the weak areas in their approach towards adopting the Agile (XP) methodology before the real life software project execution. The learning kit is designed keeping in mind the team work involved, creative thinking and other human aspects that enable the ‘discipline in chaos’ behavior for a successful software project execution. The learning kit takes about 2 hours practically to implement with a participant group and encompass all twelve XP practices within. It is designed in a technology independent manner while maintaining a simple and close vision of the technology world. Even though the above Agile methodology learning kit is explained with reference to learning XP practices, one can envision using the above learning kit to learn other Agile methodologies, such as Feature Driven Development, Dynamic System Development Methods, Agile Unified Process, EVO, and Crystal Methods.

Market leaders in Agile implementation/consulting and training have so far conducted training focused on only some aspects such as planning, estimation, collaboration and communication. It does not appear that all 12 XP practices within a single practical learning kit selectively using alphanumeric/picture puzzles and timed iterations have been implemented by other market leaders in an approach that is technology-independent. The present technology-independent approach using combination of numeric, alphanumeric/pictorial puzzles and brain teasers enables participants from entirely different or no technical background/s to participate and effectively learn XP concepts.

The details on key structural differences of the present subject matter (Extra Power Game-Learning Kit) as compared to the existing Learning Kits (available in several internet sites, class room trainings offered by different vendors and subject matter books) are shown in the table below:

| | | | | Is it a | | |
|---|---|---|---|---|---|---|
| | | | How is it handled | new way | | |
| S. | | | in the present | of | In what sense | |
| No. | Structural difference criteria | | Learning kit? | implementation? | is it unique? | Remarks |
| A | Coverage of all 12 practices of | | Inventor has used | Yes | It is the only | Other kits from |
| | Extreme Programming in a | | combination and | | Learning Kit | different vendors |
| | single practical learning kit. | | overlapping thread | | that covers all | have only focused on |
| | | | of alpha-numeric | | 12 XP Practices | ‘planning game’, |
| | | | and pictorial | | in a technology | ‘short release’ and |
| | | | puzzles/brain | | independent | ‘onsite customer’ |
| | | | Teasers to create a | | manner (No | practices. There is no |
| | | | close connection of | | computer is | single or combination |
| | | | all 12 practices of | | required while | of learning kits |
| | | | Extreme. | | learning the | available for covering |
| | | | Programming in a | | Extreme | all XP practices. |
| | | | single practical | | Programming | Only, there could be |
| | | | learning kit. | | using this | some learning |
| | | | | | Learning Kit) | modules to cover the |
| | | | | | | concepts on ‘Pair |
| | | | | | | Programming’, ‘Re- |
| | | | | | | factoring’ and |
| | | | | | | ‘Continuous |
| | | | | | | Integration’. |
| | | | | Is it a | | |
| | | Brief | How is it handled | new way | | |
| | XP | description of | in the present | of | In what sense | |
| B | Practice | the XP Practice | Learning kit? | implementation? | is it unique? | Remarks |
| 1 | Metaphor | All stakeholders | In ‘Extra Power | Yes | In Extra Power | No example is found |
| | | should have | Game - Learning | | Game - | of an existing |
| | | common vision | Kit the | | Learning Kit, | learning kit that can |
| | | and mission | participating | | the customer | closely exhibits the |
| | | toward the | group/team uses | | and team use a | ‘Metaphor’ practice |
| | | delivery. They | ‘Sudoku’ ® as | | metaphor such | of ‘Extreme |
| | | should be able to | metaphor to | | as ‘Sudoku’. | Programming’. |
| | | relate to the | represent the | | Throughout the | |
| | | whole picture in | business rules. This | | execution of | |
| | | their respective | metaphor helps the | | this learning kit, | |
| | | purview. | team to devise the | | all stakeholders | |
| | | | high level | | can experience | |
| | | | architecture. Then | | the advantage | |
| | | | the team picks | | of the | |
| | | | story cards for the | | ‘Metaphor’ | |
| | | | iterations in a | | practice within | |
| | | | manner that relates | | Extreme | |
| | | | to ‘Sudoku’ rules. | | Programming. | |
| | | | The team continues | | The metaphor | |
| | | | to follow ‘Sudoku’ | | of Extra Power | |
| | | | as the guiding | | Game - | |
| | | | principle while | | Learning Kit | |
| | | | working towards | | helps the team | |
| | | | completion of the | | to devise the | |
| | | | Extra Power Game - | | high level | |
| | | | Learning Kit. | | architecture. It | |
| | | | | | enables the | |
| | | | | | customer to | |
| | | | | | verify the | |
| | | | | | architecture | |
| | | | | | devised by the | |
| | | | | | team. Then the | |
| | | | | | team picks the | |
| | | | | | story cards for | |
| | | | | | the iterations in | |
| | | | | | a manner that | |
| | | | | | relates to | |
| | | | | | metaphor rules. | |
| | | | | | The team | |
| | | | | | continues using | |
| | | | | | guidance from | |
| | | | | | the metaphor | |
| | | | | | throughout. | |
| 2 | Test First | The unit test | All ‘must be’ and | Yes | The Test First | No example is found |
| | Development | cases must be | ‘should be’ | | Development | of an existing |
| | | written before | conditions within | | defined in Extra | learning kit that |
| | | developing the | story cards (A fully | | Power Game - | exhibits a technology |
| | | code to ensure | implementable | | Learning Kit is | independent, close |
| | | that the | feature/functionality | | independent of | relationship with the |
| | | application | defined in the | | any software | ‘Test First |
| | | under | user terms) are | | technology. | Development’ |
| | | development is | utilized for writing | | Extra Power | practice of ‘Extreme |
| | | thoroughly | the test case. The | | Game - | Programming’. |
| | | tested, starting | test cases are | | Learning Kit is | |
| | | from the unit | devised based on a | | designed in a | |
| | | testing level. | thorough | | way that | |
| | | | understanding of | | enforces the | |
| | | | story cards and, the | | participants to | |
| | | | solution (Code) is | | write the test | |
| | | | devised against the | | cases before | |
| | | | test case. | | devising the | |
| | | | | | solutions for | |
| | | | | | respective story | |
| | | | | | cards. | |
| 3 | Simple | Architecture | The approach to | Yes | The Simple | No example is found |
| | Design | should be made | create and maintain | | Design practice | of an existing |
| | | modular and | the ‘simple design’ | | of Extreme | learning kit that |
| | | design should be | is introduced | | Programming | exhibits technology |
| | | kept simple to | through the | | covered as part | independent, close |
| | | meet the | instructions that | | of Extra Power | relationship with the |
| | | requirements of | that are given to | | Game - | ‘Simple Design’ |
| | | given iteration | the groups/teams | | Learning Kit is | practice of ‘Extreme |
| | | only. | (who are executing | | independent of | Programming’. |
| | | | the Extra Power | | any software | |
| | | | Game - Learning | | technology. The | |
| | | | Kit) prior to start of | | pointers are | |
| | | | the iteration. | | provided in | |
| | | | | | terms of written | |
| | | | | | instructions to | |
| | | | | | participating | |
| | | | | | groups/teams | |
| | | | | | With the help of | |
| | | | | | the instruction, | |
| | | | | | the respective | |
| | | | | | group/team | |
| | | | | | moves toward | |
| | | | | | leveraging the | |
| | | | | | simple design | |
| | | | | | concept of | |
| | | | | | Extreme | |
| | | | | | Programming. | |
| 4 | Coding | The project team | All solutions | Yes | The coding | No example is found |
| | Standards | must not deviate | (code) for | | standards | of an existing |
| | | from coding | implementing | | defined in Extra | learning kit that |
| | | standards. | respective story | | Power Game - | exhibits technology |
| | | | cards must be | | Learning Kit | independent, close |
| | | | devised through | | are independent | relationship with the |
| | | | proper coding | | of any software | ‘Coding Standards’ |
| | | | standards. | | technology. The | practice of ‘Extreme |
| | | | Customer defines | | coding | Programming’. |
| | | | the coding | | standards are | |
| | | | standards to the | | designed to be | |
| | | | team. The coding | | simple and error | |
| | | | standards are | | free during | |
| | | | written in the | | implementation. | |
| | | | instruction sheet | | Clear focus on | |
| | | | for customer. | | importance of | |
| | | | | | coding | |
| | | | | | standards is | |
| | | | | | maintained | |
| | | | | | while executing | |
| | | | | | the learning kit. | |
| 5 | Re- | Software code | It is triggered due | Yes | It is triggered | No example is found |
| | factoring | should be | to the coding | | during the | of an existing |
| | | continuously | standards-rules | | course very | learning kit that |
| | | refined across | that call for inputs | | naturally, so | exhibits technology |
| | | iterations to | from evolving | | that participants | independent, close |
| | | increase the | solution of | | do not loose | relationship with the |
| | | code quality and | neighboring | | from coding | ‘Re-factoring’ |
| | | retain | stories. | | standards-rules | practice of ‘Extreme |
| | | maintainability. | | | while delivering | Programming’. |
| | | | | | fast solutions | |
| | | | | | against iterative | |
| | | | | | implementation | |
| | | | | | of the story | |
| | | | | | cards. | |
| 6 | Continuous | Any new piece | The story card in | Yes | The Continuous | No example is found |
| | Integration | of code written | iteration is | | Integration | of an existing |
| | | should be | considered for | | defined in Extra | learning kit that |
| | | immediately | scoring only if the | | Power Game - | exhibits technology |
| | | integrated and | story card for | | Learning Kit is | independent, close |
| | | tested to ensure | which the solution | | independent of | relationship with the |
| | | that it does not | is deviced is | | any software | ‘Continuous |
| | | break anything | integrated (placed | | technology. The | Integration’ practice |
| | | else, or else, the | at the appropriate | | integration | of ‘Extreme |
| | | solution should | position in the | | mechanism | Programming’. |
| | | be made | business rule's | | defined in Extra | |
| | | available | alphanumeric grid | | Power Game - | |
| | | immediately. | (with the help of | | Learning Kit | |
| | | | adhesive tape) on | | enables the | |
| | | | an immediate and | | participating | |
| | | | continuous basis. | | teams to learn | |
| | | | | | through | |
| | | | | | experience of | |
| | | | | | problems and | |
| | | | | | loss in quality | |
| | | | | | due to late | |
| | | | | | integration. | |
| 7 | Collective | Everybody in | Base on the | No | Not unique | The ‘Collective |
| | ownership | the learn must | business rules | | | ownership’ practice |
| | | take ownership | shared by the | | | of ‘Extreme |
| | | of complete | customer, | | | Programming’ is |
| | | success and | everybody in the | | | covered in a |
| | | failure. They | team participates to | | | technology |
| | | should ensure | create the | | | independent fashion |
| | | that they do not | architecture. Also | | | within other available |
| | | break anything | everybody in the | | | learning kits. |
| | | else while | team participates to | | | However it is |
| | | making their | re-factor the story | | | presented in a |
| | | changes. | cards within the | | | different approach |
| | | | business rule's | | | through Extra Power |
| | | | alphanumeric grid | | | Learning Kit. |
| | | | and ensures that | | | |
| | | | they do not break | | | |
| | | | anything else. | | | |
| 8 | Onsite | Customer being | One dedicated | No | Not unique | The ‘Onsite |
| | Customer | made available | member from each | | | Customer’ practice or |
| | | (physically) with | group of | | | ‘Extreme |
| | | the development | participants plays | | | Programming’ is |
| | | team throughout | the role of ‘Onsite | | | covered in a |
| | | the life cycle. | Customer’. He/she | | | technology |
| | | Customer should | is made available | | | independent fashion |
| | | be able to | with each team on | | | within other available |
| | | provide | full time basis to | | | learning kits. |
| | | clarification for | provide required | | | However it is |
| | | queries on the | clarification, | | | presented in a |
| | | stories. | inputs, change or | | | different approach |
| | | | add story cards and | | | through the present |
| | | | negotiate for | | | Extra Power |
| | | | consultants' | | | Learning Kit. |
| | | | availability. The | | | |
| | | | customer can | | | |
| | | | assess team's | | | |
| | | | performance very | | | |
| | | | closely due to | | | |
| | | | proximity. | | | |
| 9 | Planning | Release | Release Planning; | No | Not unique | The ‘Planning Game |
| | Game | Planning. All | Complete team and | | | (Release Planning, |
| | (Release | stake holders | the customer | | | Iteration Planning)’ |
| | Planning, | participate in | participate in the | | | practice of ‘Extreme |
| | Iteration | release planning | release planning | | | Programming’ is |
| | Planning) | meeting. Based | meeting. | | | covered in |
| | | on the high level | Team members | | | technology |
| | | estimate effort, | pick story cards to | | | independent fashion |
| | | the team arrives | implement in the | | | within other available |
| | | at a tentative | iteration based on | | | learning kits. |
| | | release date. | customer's priority | | | However it is |
| | | Customer | and technical | | | presented in a |
| | | provides his | dependencies. | | | different approach |
| | | comments on the | They estimate the | | | through Extra Power |
| | | estimates and re- | time effort required | | | Learning Kit. |
| | | organizes the | for implementation | | | |
| | | stories if | of selected story | | | |
| | | required. | cards. | | | |
| | | Developers and | | | | |
| | | customer jointly | | | | |
| | | priortize the | | | | |
| | | stories. Priority | | | | |
| | | numbers are | | | | |
| | | attached to the | | | | |
| | | stories. | | | | |
| | | Iteration | | | | |
| | | Planning. All | | | | |
| | | stake holders | | | | |
| | | participate in the | | | | |
| | | iteration | | | | |
| | | planning | | | | |
| | | meeting. | | | | |
| | | Granular | | | | |
| | | planning is done | | | | |
| | | by the | | | | |
| | | developers for | | | | |
| | | the iteration to | | | | |
| | | deliver the | | | | |
| | | working | | | | |
| | | functionality | | | | |
| | | against highest | | | | |
| | | value story cards | | | | |
| | | order. | | | | |
| 10 | Small | Each time-boxed | Time-boxed | No | Not unique | The ‘Small Releases’ |
| | Releases | iteration should | iterations of 10 | | | practice of ‘Extreme |
| | | be targeted to | minutes duration | | | Programming’ is |
| | | make a release | are defined to | | | covered in a |
| | | of fully tested | conduct Extra | | | technology |
| | | working | Power Game - | | | independent fashion |
| | | functionality of | Learning Kit to its | | | within other available |
| | | application. | completion. | | | learning kits. |
| | | | Working | | | However it is |
| | | | functionality | | | presented in a |
| | | | through integrated | | | different approach |
| | | | story cards is | | | through Extra Power |
| | | | delivered in each | | | Learning Kit. |
| | | | iteration. | | | |
| 11 | Pair | Complete | The team works on | No | Not unique | The ‘Pair |
| | Programming | functionality | each story card by | | | Programming’ |
| | | should be | pairing up. Pairs | | | practice of ‘Extreme |
| | | created in such a | rotate from | | | Programming’ is |
| | | manner that 2 | iteration to | | | covered in a |
| | | person work | iteration as one of | | | technology |
| | | together all the | them has to move | | | independent fashion |
| | | time. The pair of | out to take up the | | | within other available |
| | | people can | Agile coach role. | | | learning kits. |
| | | rotate. | One pair finishes 1 | | | However it is |
| | | | story card before | | | presented in a |
| | | | working on next | | | different approach |
| | | | story card. If a pair | | | through Extra Power |
| | | | can not resolve a | | | Learning Kit. |
| | | | card then they ask | | | |
| | | | other team | | | |
| | | | members and | | | |
| | | | finally they decide | | | |
| | | | to take help from | | | |
| | | | consultant. | | | |
| 12 | Sustainable | Any overtime- | The team | No | Not unique | The ‘Sustainable |
| | Pace | work or Extra | participates in | | | Pace’ practice of |
| | | time should be | estimation and | | | ‘Extreme |
| | | discouraged to | decides number of | | | Programming’ is |
| | | ensure higher | participants | | | covered in a |
| | | productivity and | required. The team | | | technology |
| | | good quality of | tries to achieve the | | | independent fashion |
| | | life. | plan in iteration | | | within other available |
| | | | time. Overwork | | | learning kits. |
| | | | and under | | | However it is |
| | | | utilization is | | | presented in a |
| | | | avoided. | | | different approach |
| | | | | | | through Extra Power |
| | | | | | | Learning Kit. |

In the foregoing detailed description of embodiments of the invention, various features are grouped together in a single exemplary embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., if used, are merely labels, and are not intended to impose numerical requirements on their objects.

1. A method of training team participants in learning Agile methodology for generating a required application comprises selectively using combination of numeric, alphanumeric and pictorial puzzles/brain teasers an set of role play instructions upon the team participants learning theoretical aspects of Agile methodology.

2. The method of claim 1, wherein the Agile methodology comprises Extreme programming (XP) practices.

3. The method of claim 2, wherein the XP practices selected from the group consisting of Metaphor, Onsite Customer, Planning Game, Small Release, Sustainable Pace, Simple Design, Re-factoring, Testing First Development, Pair Programming, coding Standards, Continuous Integration, and Collective Ownership.

4. The method of claim 2, wherein selectively using the numeric, alphanumeric and pictorial puzzles/brain teasers comprises:
selectively combining numeric, alphanumeric and pictorial puzzles/brain teasers to create user story cards and the set of role play instructions that drives connections between different user story cards.

5. The method of claim 3, wherein training the team participants in learning XP practices for generating the required application, comprises:
forming multiple subgroups using the training team participants, wherein each subgroup plays a predetermined number of roles to be performed by the training team participants;
handing over the set of role play instructions to each team participant playing one of the predetermined number of roles in each subgroup;
handing over the created user story cards to team participants from each subgroup; and
playing the game per the set of role play instructions and the created story cards iteratively by the team participants until the required application is achieved by any one of the subgroups.

6. The method of claim 5, wherein the predetermined number of roles is substantially less than the number of training team participants.

7. The method of claim 6, wherein the predetermined number of roles includes roles selected from the group consisting of customer, Agile coach, faculty/instructor, consultant, and Agile team.

8. The method of claim 7, further comprising:
forming a separate customer role play group by using at least one team participant from each subgroup to prepare differently from each of the remaining subgroup team participants; and
using an assessment sheet by each member in the separate customer role play group so that each team participant playing the customer role can assess their associated subgroups's performance.

9. The method of claim 7, further comprising:
handing over the set of role play instructions to each team participant by an associated faculty/instructor;
clarifying any doubt each team participant may have by the associated faculty/instructor; and
assessing each subgroup's performance by an associated team participant playing the customer role.

10. The method as in claim 9, wherein the training team participants work in team pairs with a time-constraint including the step of rotating the training team participants in each said team pair in each iteration.

11. The method of claim 1, further comprising:
concluding the method of training team participants at the end of a predetermined number of playing iterations.

12. The method of claim 1, further comprising:
concluding the method of training team participants when a final solution of required application is generated by any of the subgroup's training team participants.

13. The method of claim 1, further comprising:
generating another required application by any of the training team participants upon completing the method of training team participants.
